(19) United States
(12) Patent Application Publication
(10) Pub. No.: US 2021/0242529 A1
(43) Pub. Date: Aug. 5, 2021

(54) BATTERY CELL

(71) Applicant: LG ELECTRONICS INC., Seoul (KR)

(72) Inventors: Jiyoung AHN, Seoul (KR); Seonghoon HAN, Seoul (KR)

(21) Appl. No.: 17/165,178

(22) Filed: Feb. 2, 2021

(30) Foreign Application Priority Data
Feb. 4, 2020 (KR) 10-2020-0013374

(51) Int. Cl. H01M 50/342; H01M 50/124

(52) U.S. Cl. CPC H01M 50/3425; H01M 2220/30; H01M 50/124

(57) ABSTRACT

Provided is a battery cell including a core material for providing electrical energy; and a cell housing for receiving the core material, wherein the cell housing includes a side cover; an upper cover for shielding an upward opening of the cell housing; a lower cover for shielding a downward opening of the cell housing; and a side vent groove formed in the side cover.

### CROSS-REFERENCE TO RELATED APPLICATION

This application claims priority under 35 U.S.C. § 119 to Korean Application No. 10-2020-0013374 filed on Feb. 4, 2020, whose entire disclosure is hereby incorporated by reference.

### BACKGROUND

### Field

The present disclosure relates to an exhaust gas discharge structure of a battery cell.

### 2. BACKGROUND

In general, the demand for secondary batteries is rapidly increasing due to technology development and an increase in the demand for mobile devices. For example, lithium (e.g., ion/polymer) secondary batteries with relatively high energy densities and operating voltages and relatively excellent storage and lifespan characteristics are widely used as an energy source for various mobile devices and other electronic products.

Korean Laid-open Patent Publication No. 2014-0130859 describes a pouch-type secondary battery with improved safety, and in the pouch-type secondary battery, a channel is formed inside a cell and in a sealing portion of an electrode tab. When a gas is excessively generated inside a pouch due to overcharging, an internal short circuit, or other cause, an internal pressure is thus increased, and the gas may be discharged to the outside of the pouch through the channel. Thus, when the gas inside the cell is discharged to the outside of the battery, the gas is always passes through the sealing portion of the electrode tab so that a discharge direction and path of the gas can be predicted in advance.

However, in this pouch-type secondary battery, channels are formed at upper and lower surfaces of the pouch, and electrodes are disposed at the upper and lower surfaces of the pouch, and an outer lead frame and the upper and lower surfaces of the pouch are welded by a resistance welding machine for connection. During a welding process to attach the electrodes after the channels are formed at the upper and lower surfaces of the pouch, the channels may be opened and/or damaged during welding, thereby damaging the battery cells. Further, when a channel is formed at the upper surface or the lower surface of the pouch, when exhaust gas inside the battery cell is discharged, other contents of the battery cell, such as potentially hazardous chemicals used in a lithium ion battery, may also be discharged to the outside of the battery pack via the channel.

The above reference is incorporated by reference herein where appropriate for appropriate teachings of additional or alternative details, features and/or technical background.

### BRIEF DESCRIPTION OF THE DRAWINGS

The embodiments will be described in detail with reference to the following drawings in which like reference numerals refer to like elements wherein:

FIG. 1 is a side elevation view illustrating a use state of a cleaner according to an embodiment of the present disclosure.

FIG. 2 is a perspective view of a cleaner 1 in which a nozzle module 70 is removed from FIG. 1.

FIG. 3 is a side elevation view of the cleaner 1 of FIG. 2.

FIG. 4A is a top elevation view of the cleaner 1 of FIG. 2.

FIG. 4B is a top elevation view of a cleaner 1 according to another embodiment.

FIG. 5 is a plan view of the cleaner 1 of FIG. 3 horizontally taken along a line S1-S1′.

FIG. 6 is a cross-sectional view of the cleaner 1 of FIG. 4A vertically taken along a line S2-S2′.

FIG. 7A is an exploded perspective view of a battery cell according to an embodiment of the present disclosure.

FIG. 7B is a perspective view illustrating a coupled state of the battery cell of FIG. 7A.

FIG. 8 is a vertical cross-sectional view of the battery cell of FIG. 7B.

FIG. 9 is a diagram illustrating an operation state when a gas is discharged from the battery cell of FIG. 8.

FIG. 10 is a perspective view of a battery cell according to another embodiment of the present disclosure.

FIG. 11 is a cross-sectional view taken along a line S11-S12 of FIG. 10.

FIG. 12 is a diagram illustrating an operation state when a gas is discharged from the battery cell of FIG. 10.

FIG. 13 is a perspective view of a battery cell according to another embodiment of the present disclosure.

FIG. 14 is a cross-sectional view taken along a line S21-S22 of FIG. 13.

FIG. 15 is a diagram illustrating an operation state when a gas is discharged from the battery cell of FIG. 13.

### DETAILED DESCRIPTION

Hereinafter, the present disclosure will be described based on a spatial rectangular coordinate system formed by the X-axis, Y-axis, and Z-axis that are orthogonal to each other. Each axis direction (e.g., X-axis direction, Y-axis direction, Z-axis direction) means both directions in which each axis extends. A ‘+’ sign in front of each axis direction (e.g., +X-axis direction, +Y-axis direction, +Z-axis direction) means a positive direction, which is one of both directions in which each axis extends. A ‘−’ sign in front of each axis direction (e.g., −X-axis direction, −Y-axis direction, −Z-axis direction) means a negative direction, which is the other direction of both directions in which each axis extends. Expressions referring to directions such as “front(+Y)/rear(−Y)/left(+X)/right(−X)/up(+Z)/down(−Z)” mentioned below may be defined according to the XYZ coordinate axis, but it should be appreciated that specific directions are used herein for describing examples in certain embodiments so that the present disclosure may be more clearly understood, and that directions may be defined differently according to where the reference is placed.

The following discussion describes a cleaner as an example of a device that may include or by be powered by a disclosed battery cell. However, it should be appreciated that the battery cell may be used in various different devices and is it intended to be limited to use in a cleaner. A cleaner according to the present disclosure may be a manual cleaner or a robot cleaner. Hereinafter, a cleaner 1 according to the present embodiment will be described only as a hand-held manual cleaner, but the cleaner according to the present disclosure need not be limited thereto.

<Cleaner Including a Battery>

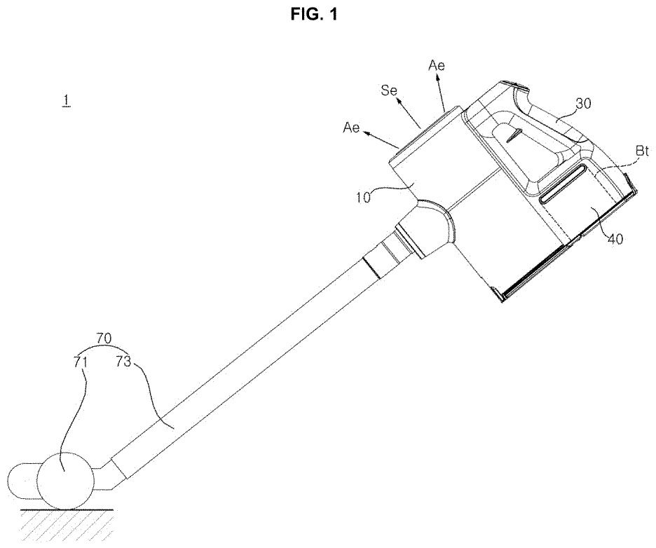

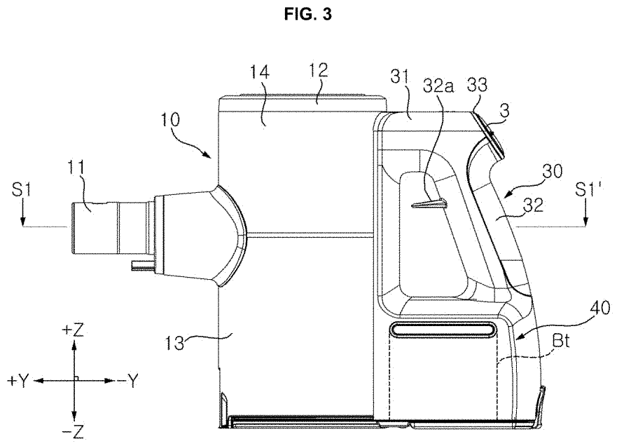

Referring to FIGS. 1 to 6, a cleaner 1 according to an embodiment includes a main body 10 for forming a flow path P for guiding sucked air to be filtered and then discharged to the outside. The cleaner 1 includes a dust separator 20 disposed on the flow path P to separate dust from the air. The cleaner 1 includes a handle 30 coupled to the rear side of the main body 10.

The cleaner 1 includes a battery Bt for supplying power and a battery housing 40 in which the battery Bt is received. The cleaner 1 includes one or more fan modules 50 disposed on the flow path P to move air in the flow path P. In addition to the dust separator 20, the cleaner 1 may include one or more filters 61 and 62 disposed on the flow path P to separate dust from the air.

The cleaner 1 includes a nozzle module 70 detachably connected to a suction pipe 11 of the main body 10. The cleaner 1 includes an input unit 3 for enabling a user to input on/off or a suction mode thereof, and an output unit 4 for displaying various statuses thereof to the user.

The cleaner 1 includes one or more noise control modules 80 for performing at least one of i) a first function of reducing the loudness of noise in a relatively low band area among audible frequencies, or ii) a second function of increasing the loudness of noise in a relatively high band area among audible frequencies. The noise control module 80 includes one or more speakers 89 for outputting a sound. According to an embodiment, the cleaner 1 may further include a sound transfer pipe 90 for transferring a sound from the speakers 89 to one or more sound emission ports 10b and 10b′.

Referring to FIG. 1, the nozzle module 70 includes a nozzle portion 71 provided to suck external air and an extension pipe 73 long extended from the nozzle portion 71. The extension pipe 73 connects the nozzle portion 71 and the suction pipe 11. The extension pipe 73 guides the air sucked from the nozzle portion 71 to be introduced into the suction flow path P1. One end of the extension pipe 73 may be detachably coupled to the suction pipe 11 of the main body 10. The user may clean while holding the handle 30 and moving the nozzle portion 71 in a state in which the nozzle portion 71 is placed on a cleaning surface.

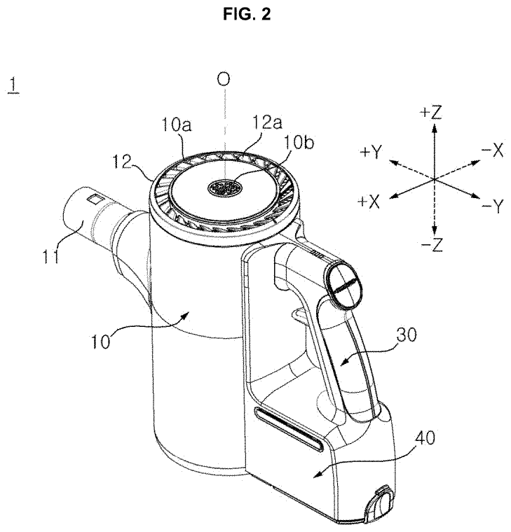

Referring to FIGS. 2 to 7, the main body 10 forms an external shape of the cleaner 1. The main body 10 may be formed in a vertically long cylindrical shape as a whole. The dust separator 20 is received inside the main body 10. The fan modules 50 are received in the main body 10. The handle 30 is coupled to or otherwise provided at the rear side of the main body 10. The battery housing 40 may be coupled to the rear side of the main body 10, such as below the handle 30.

The main body 10 includes a suction pipe 11 for guiding the suction of air therein. The suction pipe 11 forms the suction flow path P1. The suction pipe 11 may be protruded forward of the main body 10.

The main body 10 includes one or more discharge covers 12 and 12′ for forming one or more exhaust ports 10a and 10a′. The discharge covers 12 and 12′ may further form one or more sound emission ports 10b and 10b′. The discharge covers 12 and 12′ may form an upper surface of the main body 10. The discharge covers 12 and 12′ cover an upper side of a fan module housing 14.

The main body 10 includes a dust collection portion 13 for storing dust separated from the dust separator 20. At least a part of the dust separator 20 may be disposed in the dust collection portion 13. An inner surface of the upper part of the dust collection portion 13 may perform a function of a first cyclone portion 21 to be described later. (In this case, the upper part of the dust collection portion 13 may be referred to as the first cyclone portion 21.) A second cyclone portion 22 and a dust flow guide 24 are disposed inside the dust collection portion 13.

The dust collection portion 13 may be formed in a substantially cylindrical shape. The dust collection portion 13 is disposed under the fan module housing 14. Dust storage spaces S1 and S2 are formed inside the dust collection portion 13. A first storage space S1 is formed between the dust collection portion 13 and the dust flow guide 24. A second storage space S2 is formed inside the dust flow guide 24.

The main body 10 includes a fan module housing 14 for receiving the fan module 50 therein. The fan module housing 14 may be formed to extend upward from the dust collection portion 13. The fan module housing 14 is formed in a cylindrical shape. An extension portion 31 of the handle 30 is disposed at the rear side of the fan module housing 14.

The main body 10 includes a dust cover 15 provided to open and close the dust collection portion 13. The dust cover 15 may be rotatably coupled to the lower side of the dust collection portion 13. The dust cover 15 may open and close the lower side of the dust collection portion 13 by a rotation operation. The dust cover 15 may include a hinge (not illustrated) for rotation. The hinge may be coupled to the dust collection portion 13. The dust cover 15 may open and close the first storage space S1 and the second storage space S2 together.

The main body 10 includes an air guide 16 for guiding the air discharged from the dust separator 20. The air guide 16 forms fan module flow path P4 for guiding air from the dust separator 20 to impeller 51′. The air guide 16 includes exhaust flow path P5 for guiding the air passing through the impellers 51 to the exhaust ports 10a and 10a′. The air guide 16 may be disposed within the fan module housing 14.

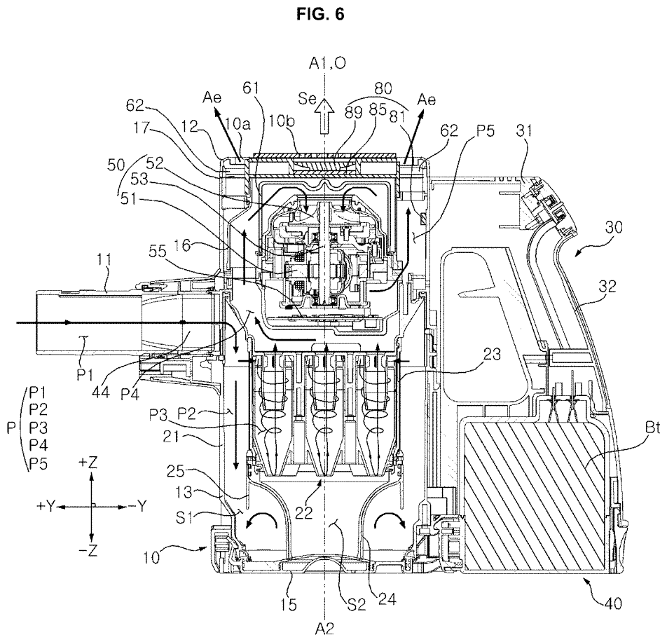

For example, referring to FIG. 6, the air guide 16 may form flow paths P4 and P5 so that the air discharged from the dust separator 20 rises, passes through the impeller 51, and descends, and rises again to the exhaust ports 10a and 10a′. As another example, the air guide 16 may form flow paths P4 and P5 so that the air discharged from the dust separator 20 passes through the impeller 51 and continues to rise to the exhaust ports 10a and 10a′.

Referring to FIGS. 2, 4A, 4B, and 6, the main body 10 has exhaust ports 10a and 10a′ for discharging air in the flow path P to the outside of the main body 10. The exhaust ports 10a and 10a′ may be formed in the exhaust covers 12 and 12′.

The exhaust ports 10a and 10a′ may be disposed at one surface of the main body 10. The exhaust ports 10a and 10a′ may be formed at an upper side of the main body 10. Thereby, it is possible to prevent a phenomenon that the air discharged from the exhaust ports 10a and 10a′ directly hits the user while preventing dust around the cleaner from being scattered by the air discharged from the exhaust ports 10a and 10a′. Further, the sound emission port may be disposed at the same surface as that in which the exhaust ports 10a and 10a′ are formed among surfaces of the main body 10. The exhaust ports 10a and 10a′ may be disposed to face a specific direction (e.g., upward direction). A discharge direction Ae of the air discharged through the exhaust ports 10a and 10a′ may be a specific direction.

In the present description, a predetermined axis O refers to a virtual axis extended in a specific direction while crossing the center of the main body 10. A ‘centrifugal direction’ means a direction away from the axis O, and a ‘centrifugal opposite direction’ means a direction closer to the axis O. Further, a ‘circumferential direction’ means a circumferential direction (or rotational direction) around the axis O. The circumferential direction is meant to encompass both clockwise and counterclockwise directions.

An air discharge direction Ae may be a direction between a specific direction (e.g., a vertical and/or horizontal direction) and a centrifugal direction. The air discharge direction Ae may be a direction between a specific direction and a circumferential direction. Specifically, the air discharge direction Ae may be a direction between a specific direction and a counterclockwise direction. The air discharge direction Ae may be a direction in which a specific direction, a centrifugal direction, and a circumferential direction are three-dimensionally combined.

The exhaust ports 10a and 10a′ may be disposed to enclose the axis O. The exhaust ports 10a and 10a′ may be arranged or extended along the circumferential direction. The exhaust ports 10a and 10a′ may be disposed in predetermined peripheral areas B1 and B1′ extended over a central angle of 180 degrees along a circumferential direction around a predetermined axis O.

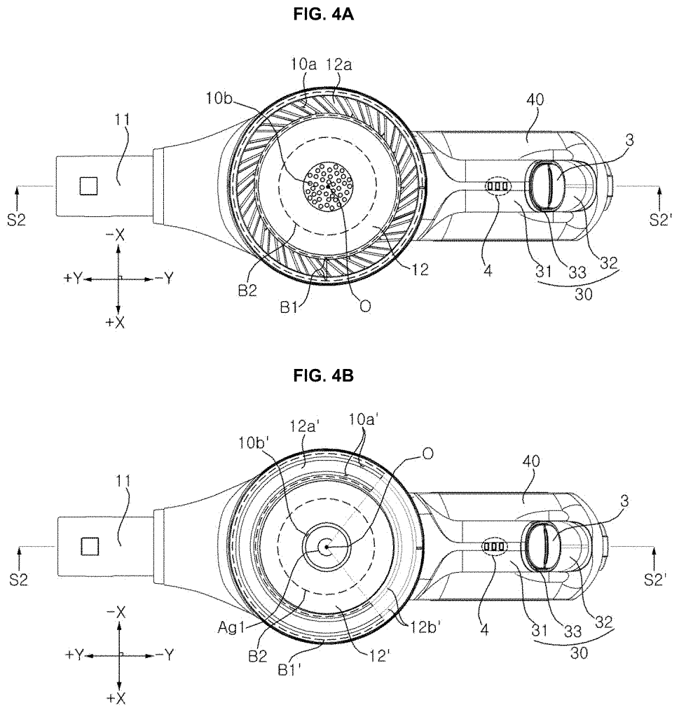

For example, referring to FIG. 4A, the peripheral area B1 is extended to a center angle of 360 degrees along the circumferential direction around the axis O. That is, the peripheral area B1 completely encloses a circumference of the axis O. As another example, referring to FIG. 4B, the peripheral area B1′ is extended along the circumferential direction around the axis O by a central angle Ag1. Here, the central angle Ag1 may have a value of 270 degrees or more and less than 360 degrees. In FIG. 4A, the central angle Ag1 is about 270 degrees.

Referring to FIG. 4B, it is preferable that a direction in which the peripheral area B1′ is not enclosed based on the axis O is a direction (rear) in which the handle 30 is disposed. The exhaust port 10a′ may not be formed in an area between the axis O and the handle 30 so that the air discharged from the exhaust port 10a′ is prevented from flowing toward the user. A barrier 12b′ for blocking air discharge may be provided in an area between the axis O and the handle 30. Thereby, it is possible to prevent the air discharged from the exhaust port 10a′ from directly hitting the user holding the handle 30.

The exhaust ports 10a and 10a′ may be i) extended along the circumferential direction or ii) arranged along the circumferential direction by dividing into a plurality of pieces in the peripheral areas B1 and B1′. For example, referring to FIG. 4A, a plurality of exhaust ports 10a are arranged along the peripheral area B1. The plurality of exhaust ports 10a are divided from each other in the circumferential direction by the plurality of exhaust guides 12a. The plurality of exhaust ports 10a may be arranged at predetermined intervals apart from each other along the circumferential direction.

As another example, referring to FIG. 4B, the exhaust port 10a′ is extended long along the peripheral area B1′. A plurality of exhaust ports 10a′ may be disposed to be spaced apart from each other in a centrifugal direction. The plurality of exhaust ports 10a′ are divided from each other in the centrifugal direction by the exhaust guide 12a′. Each of the exhaust ports 10a′ may be extended in the circumferential direction by the central angle Ag1 about the axis O.

The main body 10 includes exhaust guides 12a and 12a′ provided to discharge air discharged through the exhaust ports 10a and 10a′ in a direction inclined based on the axis O. The exhaust guides 12a and 12a′ may be disposed to be inclined based on the axis O. The exhaust covers 12 and 12′ may include exhaust guides 12a and 12a′ for dividing the exhaust ports 10a and 10a′ into a plurality of pieces.

For example, referring to FIG. 4A, the exhaust cover 12 includes a plurality of exhaust guides 12a for dividing the exhaust port 10a into a plurality of pieces. The plurality of exhaust guides 12a are arranged to be spaced apart along the circumferential direction. Each exhaust guide 12a is extended in a direction between a circumferential direction and a centrifugal direction, and divides two adjacent exhaust ports 10a. A space apart between the two adjacent exhaust guides 12a becomes the exhaust port 10a. The exhaust guide 12a guides air to be discharged in a direction in which a specific direction, a centrifugal direction, and a circumferential direction are three-dimensionally combined.

As another example, referring to FIG. 4B, the exhaust cover 12′ includes one exhaust guide 12a′ for dividing the exhaust port 10a′ into two. The exhaust guide 12a′ is extended long along the circumferential direction. The exhaust guide 12a′ is extended in the circumferential direction from one end to the other end of the barrier 12b′ by a central angle Ag1 around the axis O. The exhaust guide 12a′ guides air to be discharged in a direction in which a specific direction and a centrifugal direction are combined.

Referring to FIGS. 2, 4A, 4B, and 6, the main body 10 forms sound emission ports 10b and 10b′ for emitting a sound from the speakers 89. The sound emission ports 10b and 10b′ may be formed in the discharge covers 12 and 12′. The sound emission ports 10b and 10b′ may be formed at the upper side of the main body 10. The sound emission ports 10b and 10b′ may be disposed to face a specific direction (e.g., upward direction). An emission direction Se of a sound emitted through the sound emission ports 10b and 10b′ becomes a specific direction. The sound emission ports 10b and 10b′ are preferably provided separately from the exhaust ports 10a and 10a′. Thereby, it is possible to prevent the effect of air or dust moving in the flow path P on a performance of the speakers 89.

It is preferable that the exhaust ports 10a and 10a′ and the sound emission ports 10b and 10b′ face the same direction based on the main body 10. Thereby, when the noise emitted through the exhaust ports 10a and 10a′ and the sound emitted through the sound emission ports 10b and 10b′ are synthesized to reach the user's ear, it is possible to reduce a phenomenon in which a ratio between the loudness of the noise and the loudness of the sound varies according to a position of the user's ear, and to synthesize the sound with the noise at a preset ratio.

The sound emission ports 10b and 10b′ may be disposed at the center of the discharge covers 12 and 12′. The sound emission ports 10b and 10b′ may be disposed in a centrifugal opposite direction of the peripheral areas B1 and B1′ based on the axis O. The sound emission ports 10b and 10b′ may be disposed in a central portion through which the axis O passes. The sound emission ports 10b and 10b′ may be spaced apart in the centrifugal opposite direction in the peripheral areas B1 and B1′ and be disposed in a predetermined central area B2 through which the axis O passes. Thereby, it is possible to place a sound generation area by the sound emission ports 10b and 10b′ at the center of a noise generation area by the exhaust ports 10a and 10a′, and noise by the exhaust ports 10a and 10a′ and a sound by the speakers 89 may be destructive interference or constructive interference as preset. This is particularly effective in canceling out (destructive interference) a lowband frequency range of the generated noise with the 180 degree phase-shifted sound of the speakers 89.

As an example, referring to FIG. 2, the sound emission port 10b may include a plurality of holes formed to be spaced apart from each other in the central area B2. As another example, referring to FIG. 4A, a mesh-type structure may be disposed in the central area B2, and a large number of holes formed by the mesh-type structure may perform a function of the sound emission port 10b. As another example, referring to FIG. 4B, the sound emission port 10b′ may include a gap long extended in the circumferential direction about the axis O within the central area B2. Specifically, the sound emission port 10b′ may include a ring-shaped gap.

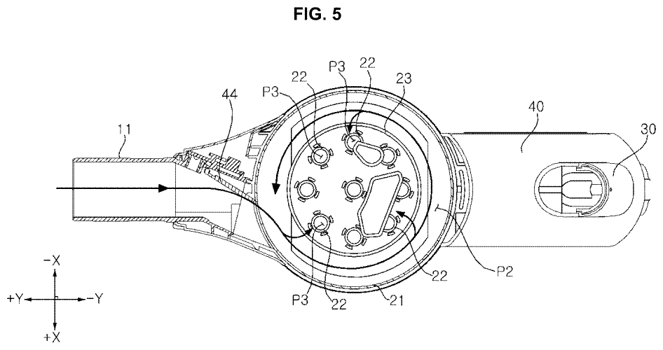

Referring to FIGS. 5 and 6, the dust separator 20 performs a function of filtering dust on the flow path P. The dust separator 20 separates dust sucked into the main body 10 through the suction pipe 11 from the air. As an example, the dust separator 20 may include a first cyclone portion 21 and a second cyclone portion 22 capable of separating dust by cyclone flow. The flow path P2 formed by the first cyclone portion 21 may be connected to the suction flow path P1 formed by the suction pipe 11. Air and dust sucked through the suction pipe 11 helically flow along an inner circumferential surface of the first cyclone portion 21.

An axis A2 of cyclone flow of the first cyclone portion 21 may be extended in a vertical direction. The axis A2 of cyclone flow may coincide with the axis O. The second cyclone portion 22 additionally separates dust from the air that has passed through the first cyclone portion 21. The second cyclone portion 22 may be located inside the first cyclone portion 21. The second cyclone portion 22 may be located inside a boundary portion 23. The second cyclone portion 22 may include a plurality of cyclone bodies disposed in parallel.

As another example, the dust separator 20 may have a single cyclone portion. Even in this case, the axis A2 of the cyclone flow may be extended in the vertical direction. As another example, the dust separator 20 may include a main filter portion (not illustrated) instead of a cyclone portion. The main filter portion may separate dust from the air introduced from the suction pipe 11. Hereinafter, the dust separator 20 will be described based on the present embodiment including the first cyclone portion 21 and the second cyclone portion 22, but is not necessarily limited thereto.

The dust separator 20 forms dust separation flow paths P2 and P3. The air moves the dust separation flow paths P2 and P3 at a high speed to separate the dust from the air, and the separated dust is stored in the first dust storage space S1. A space between an inner circumferential surface of the first cyclone portion 21 and an outer circumferential surface of the boundary portion 23 becomes the flow path P2 of first cyclone. The air passing through the suction flow path P1 moves in a downward spiral direction in the flow path P2 of the first cyclone, and dust in the air is centrifuged. Here, the axis A2 becomes the flow axis A2 in the downward spiral direction.

The dust separator 20 includes a boundary portion 23 disposed in a cylindrical shape inside the first cyclone portion 21. The boundary portion 23 forms a plurality of holes at the outer circumferential surface. Air in the first cyclone flow path P2 may pass through the plurality of holes of the boundary portion 23 and be introduced into the second cyclone flow path P3. The bulky dust may also be filtered by a plurality of holes in the boundary portion 23.

The upper side of the second cyclone portion 22 is disposed inside the boundary portion 23. The second cyclone portion 22 includes a plurality of cyclone bodies having an empty interior and penetrated vertically. Each cyclone body may be formed in a pipe shape that tapers downward. The second cyclone flow path P3 is formed inside each cyclone body. The air passing through the boundary portion 23 moves to the second cyclone flow path P3 along a guide for guiding air flow in a downward spiral direction disposed at the upper side of the cyclone body. The air spirally moves downward along the inner circumferential surface of the cyclone body, the dust in the air is centrifuged, and the separated air is stored in the second storage space S2. The air that has moved to the lower side of the cyclone body along the second cyclone flow path P3 moves upwardly along a central axis in the vertical direction of the second cyclone flow path P3, and is introduced into the fan module flow path P4.

The dust separator 20 includes a dust flow guide 24 for dividing the first storage space S1 and the second storage space S2 within the dust collection portion 13. A space between the dust flow guide 24 and an inner surface of the dust collection portion 13 is a first storage space S1. An internal space of the dust flow guide 24 is the second storage space S2.

The dust flow guide 24 is coupled to the lower side of the second cyclone portion 22. The dust flow guide 24 contacts the upper surface of the dust cover 15. A portion of the dust flow guide 24 may be formed to decrease in diameter as advancing from the top to the bottom. As an example, the upper portion of the dust flow guide 24 may be formed to have a smaller diameter toward the lower side, and the lower portion of the dust flow guide 24 may be formed in a cylindrical shape extended vertically.

The dust separator 20 may include a scattering prevention rib 25 extended downward from the upper end of the dust flow guide 24. The dust separator 20 may enclose a periphery of the upper portion of the dust flow guide 24. The scattering prevention rib 25 may be extended along a circumferential direction about the flow axis A2. For example, the scattering prevention rib 25 may be formed in a cylindrical shape.

When the upper portion of the dust flow guide 24 is formed to have a smaller diameter toward the lower side, a space is formed between an outer peripheral surface of the upper portion of the dust flow guide 24 and the scattering prevention rib 25. When the rising flow of air occurs along the dust flow guide 24 in the first storage space S1, rising dust is caught by the space between the scattering prevention rib 25 and the upper portion of the dust flow guide 24. Thereby, it is possible to prevent the dust in the first storage space S1 from flowing backward to the upside.

The handle 30 is coupled to the main body 10. The handle 30 may be coupled to the rear side of the main body 10. The handle 30 may be coupled to the upper side of the battery housing 40. The handle 30 includes an extension portion 31 protruded and extended from the main body 10 to the rear. The extension portion 31 may be extended forward from the upper part of an additional extension portion 32. The extension portion 31 may be extended in a horizontal direction. In another embodiment, the speaker 89 may be disposed inside the extension portion 31.

The handle 30 is extended in a vertical direction and includes an additional extension portion 32. The additional extension portion 32 may be spaced apart from the main body 10 in the front-rear direction. The user may use the cleaner 1 while holding the additional extension portion 32. The upper end of the additional extension portion 32 is connected to the rear end of the extension portion 31. The lower end of the additional extension portion 32 is connected to the battery housing 40.

The additional extension portion 32 may be provided with a movement limiting portion 32a for preventing the hand from moving in a length direction (up and down direction) of the additional extension portion 32 in a state in which the user holds the additional extension portion 32. The movement limiting portion 32a may be protruded forward from the additional extension portion 32.

The movement limiting portion 32a is disposed to be spaced apart from the extension portion 31 vertically. In a state in which the user is holding the additional extension portion 32, some fingers of the user's holding hand are located over the movement limiting portion 32a, and the remaining fingers are located under the movement limiting portion 32a.

The handle 30 may include an inclined surface 33 facing a direction between the upper side and the rear side. The inclined surface 33 may be located at the rear of the extension portion 31. The input unit 3 may be disposed at the inclined surface 33.

The battery Bt may supply power to the fan module 50. The battery Bt may supply power to the noise control module. The battery Bt may be detachably disposed inside the battery housing 40. The battery housing 40 is coupled to the rear side of the main body 10. The battery housing 40 is disposed under the handle 30. The battery Bt is received in the battery housing 40. A heat dissipation hole for discharging a heat generated in the battery Bt to the outside may be formed in the battery housing 40.

Referring to FIG. 6, the fan module 50 generates a suction force so that external air flows into the flow path P. The fan module 50 is disposed within the main body 10. The fan module 50 is disposed under the sound emission ports 10b and 10b′. The fan module 50 is disposed over the dust separator 20.

The fan modules 50 includes impeller 51 for generating a suction force by rotation. The impeller 51 pressurizes air so that the air in the flow path P is discharged through the exhaust ports 10a and 10a′. When the impeller 51 pressurizes air, noise and vibration are generated, and these noises are mainly emitted through the exhaust ports 10a and 10a′.

An extension line of the rotation axis A1 (which may also be referred to as an axis of the suction motor) of the impeller 51 may coincide with the flow axis A2. Further, the rotation axis A1 may coincide with the axis O. In this case, the impellers 51 and 51′ rotate around the axis O to pressurize the air. Thereby, noise may be relatively evenly emitted through the exhaust ports 10a and 10a′ formed in the peripheral areas B1 and B1′.

The fan modules 50′ may include suction motor 52 for rotating the impeller 51. The suction motor 52 may be the only motor of the cleaner 1. The suction motor 52 may be located over the dust separator 20. When the suction motors 52 operates, noise and vibration are generated, and these noises are mainly emitted through the exhaust ports 10a and 10a′.

For example, referring to FIG. 6, the fan module 50 in which the impeller 51 is disposed under the suction motor 52 may be provided. The impeller 51 pressurizes air in an upward direction when rotating. As another example, the fan module 50 in which the impeller 51 may be disposed under the suction motor 52 may be provided. The impeller 51 may then pressurize air in a downward direction when rotating.

The fan modules 50 may include a shaft 53 fixed to the center of the impeller 51. The shaft 53 is disposed to extend in a vertical direction on the rotation shaft A1. The shaft 53 may function as a motor shaft of the suction motor 52.

The cleaner 1 may include a printed circuit board (PCB) 55 for controlling the suction motor 52. The PCB 55 may be disposed between the suction motor 52 and the dust separator 20.

The cleaner 1 may include a pre-filter 61 for filtering air before air is sucked into the suction motors 52′. The pre-filter 61 may be disposed to enclose the impeller 51. Air on the fan module flow path P4 passes through the pre-filter 61 to reach the impeller 51. The pre-filter 61 is disposed inside the main body 10. The pre-filter 61 is disposed under the discharge covers 12 and 12′. By separating the discharge covers 12 and 12′ from the cleaner 1, the user may remove the pre-filter 61 from the inside of the main body 10.

The cleaner 1 may include a high-efficiency particulate air (HEPA) filter 62 for filtering air before the air is discharged through the exhaust ports 10a and 10a′. The air that has passed through the impellers 51 may pass through the HEPA filter 62 and then be discharged to the outside through the exhaust port 10a. The HEPA filter 62 is disposed on the exhaust flow path P5.

The discharge covers 12 and 12′ may form a filter reception space (not illustrated) for receiving the HEPA filter 62. The filter reception space may be formed to open the lower side and thus the HEPA filter 62 may be received in the filter reception space in a lower side of the discharge covers 12 and 12′. An exhaust port 10a may be formed to face the HEPA filter 62. The HEPA filter 62 is disposed under the exhaust ports 10a and 10a′. The HEPA filter 62 may be disposed to extend in a circumferential direction along the exhaust ports 10a and 10a′.

The main body 10 includes a filter cover 17 for covering the lower side of the HEPA filter 62. In a state in which the HEPA filter 62 is received in a filter reception space, the lower side of the HEPA filter 62 is covered by the filter cover 17, and the filter cover 17 has a hole through which air in the exhaust flow path P5 passes. The filter cover 17 may be detachably coupled to the discharge covers 12 and 12′.

The discharge covers 12 and 12′ may be detachably coupled to the fan module housing 14. When the filter cover 17 is separated from the exhaust covers 12 and 12′ separated from the fan module housing 14, the HEPA filter 62 may be removed from the filter reception space. In the present disclosure, it has been described that the cleaner 1 includes the pre-filter 61 and the HEPA filter 62, but there is no limitation on the type and number of filters.

The input unit 3 may be located at the opposite side of the movement limiting unit 32a based on the handle 30. The input unit 3 may be disposed at the inclined surface 33. Further, the output unit 4 may be disposed in the extension portion 31. For example, the output unit 4 may be located at an upper surface of the extension portion 31. The output unit 4 may include a plurality of transmitters 111. The plurality of transmitters 111 may be arranged to be spaced apart in a longitudinal direction (front and rear direction) of the extension portion 31.

Referring to FIGS. 5 and 6, the flow path P is formed by sequentially connecting a suction flow path P1, dust separation flow paths P2 and P3, fan module flow path P4, and exhaust flow path P5.

In particular, referring to FIG. 5, the suction flow path P1 provides external air to the dust separator 20. The suction flow path P1 is connected to the dust separator 20. Specifically, the suction flow path P1 may be defined by the suction pipe 11, a part of the suction flow path P1 may be exposed to the outside of the main body 10, and the other side of the suction flow path P1 may be located within the main body 10. One side of the suction flow path P1 may be coupled to an extension pipe 73 connected to the nozzle unit 71. The air in the suction flow path P1 is moved by the fan module. A flap door 44 for opening and closing the suction pipe 11 is installed in the suction pipe 11.

Air and dust sucked through the suction flow path P1 by an operation of the suction motors 52 and 52′ flow in the first flow path P2 and the second cyclone flow path P3 and are separated from each other. In the second cyclone flow path P3, air moves upward as described above, and is introduced into the fan module flow path P4.

The fan module flow path P4 guides air toward the pre-filter 61. Air that has sequentially passed through the pre-filter 61 and the impeller 51 flows into the exhaust flow path P5. The air in the exhaust flow path passes through the HEPA filter 62 and is then discharged to the outside through the exhaust ports 10a and 10a′.

The fan module flow path P4 guides the air so that the air discharged from the dust separator 20 rises and then passes through the impeller 51 and descends. Here, the exhaust flow path P5 guides the air so that the air descending while passing through the impeller 51 again rises to the exhaust ports 10a and 10a′.

### First Embodiment

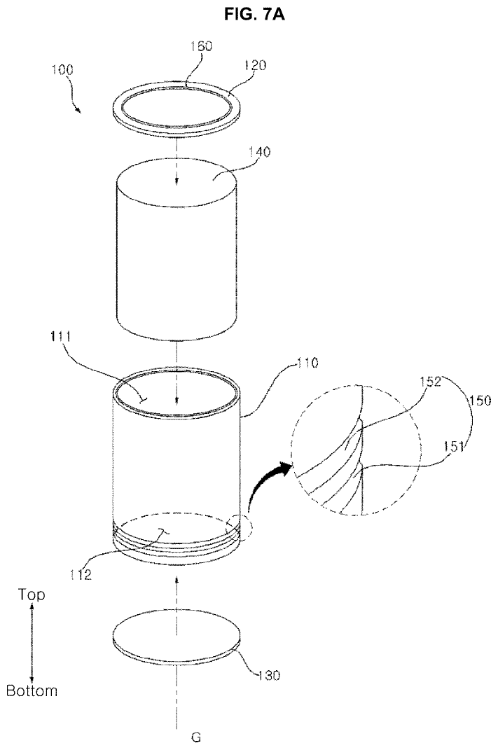

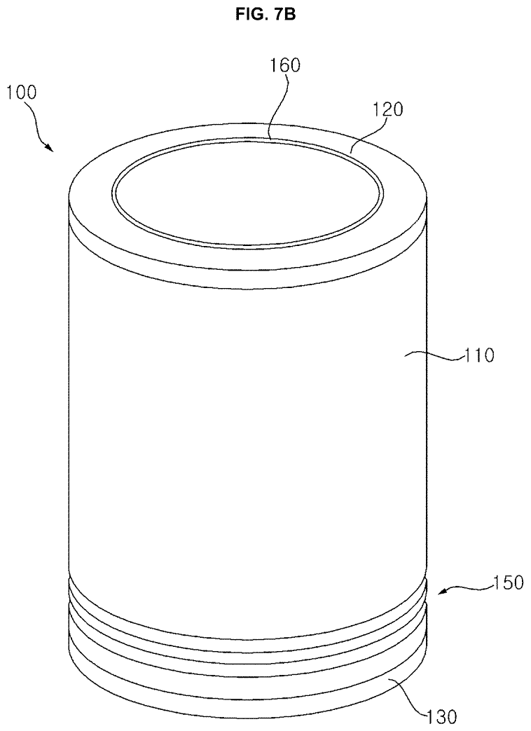

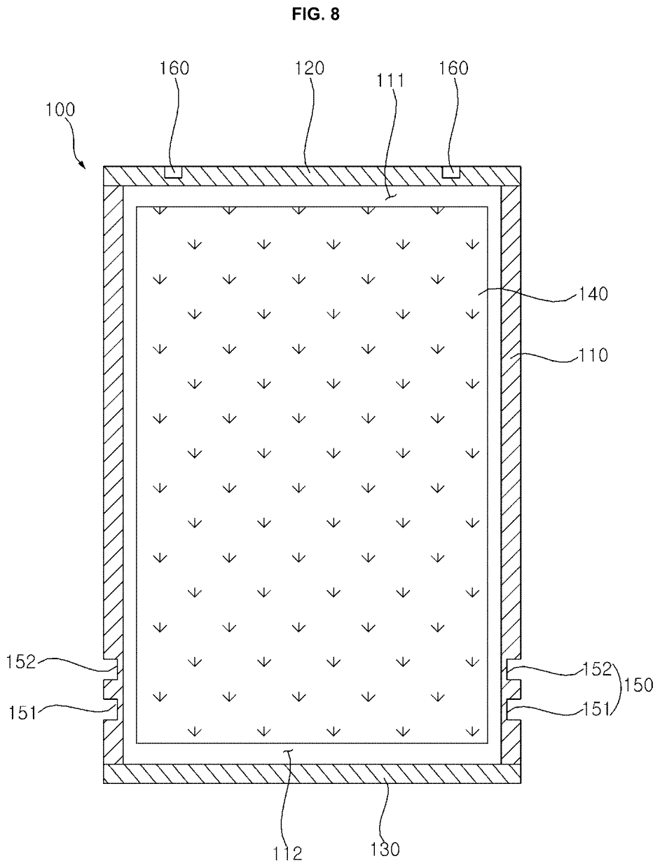

Hereinafter, a battery cell 100 constituting the above-described battery Bt will be described in detail. Referring to FIGS. 7 and 8, the battery cell 100 of the present disclosure includes a core material 140 for providing electrical energy and cell housings 110, 120, and 130 for receiving the core material 140. Referring to FIG. 6, cell housings 110, 120, and 130 may be included in or correspond to the battery housing 40 that is shaped to be received at the handle 30 of a cleaner 1.

The core material 140 provides electrical energy while discharging. For example, the core material 140 includes a positive electrode plate, a negative electrode plate, and a separator, and an electrode lead may be connected to an electrode tab extended from each of the positive electrode plate and the negative electrode plate.

The cell housings 110, 120, and 130 provide a space for receiving the core material 140, and power terminals connected to the positive electrode plate and the negative electrode plate are formed. The cell housings 110, 120, and 130 may have various shapes for receiving the core material 140.

For example, the cell housings 110, 120, and 130 may have various shapes such as a cylinder, a polyprism, and a pouch shape. Referring to FIG. 6, cell housings 110, 120, and 130 may be included in the battery housing 40 that is shaped to be received at the handle 30 of a cleaner. Specifically, the cell housings 110, 120, and 130 may include a side cover 110 opened in a vertical direction and for enclosing a housing shaft (or extension direction) G, an upper cover 120 for shielding an upward opening of the sell housing, and a lower cover 130 for shielding a downward opening of the sell housing.

The side cover 110 may have a cylindrical shape centered on the housing shaft G, and has an upward (or first) opening 111 and a downward (or second) opening 112. The side cover 110 may have a surface extended in a direction parallel to the housing shaft G. In the example shown in FIG. 6, the side cover 110 of a battery housing 40 may have one or more flat side surfaces to conform to handle 30 and to be coupled to body 10.

The upper cover (or first cover) 120 covers the upward (or first) opening 111. The upper cover 120 may define a surface crossing the housing shaft G. An electrode terminal (not illustrated) may be formed in the upper cover 120. Preferably, in the upper cover 120, the electrode terminal may not be formed, and an upper vent groove (or end vent groove) 160 may be formed. For example, the upper vent groove 160 may be formed by etching or carving away one or more portions of an inner surface or an outer surface of the upper cover 120. Alternatively, the upper vent groove 160 may be defined as an area of the upper cover 120 composed of a relatively softer material than other portions of the upper cover 120, and a thickness of the upper cover 112 at the upper vent groove 160 may correspond to a reference thickness or the thickness of the upper cover 120 at other locations. In the example shown in FIG. 6, the upper cover (or first cover) 120 may be provided at a lower region of the battery housing 40, away from the handle 30 so that upper vent groove 160 may face downward and away from the handle 30.

The upper vent groove 160 has a structure in which a part of the upper cover 120 is damaged, such as to be perforated, when a pressure increases due to the exhaust gas inside the cell housings 110, 120, and 130. For example, the upper vent groove 160 may be formed by recessing a part of the upper cover. In another example, the upper vent groove 160 may be defined as an area having a thickness smaller than that of the upper cover in the upper cover.

A cross-sectional shape of the upper vent groove 160 may be a V or U shape. The upper vent groove 160 may be extended in one direction in a line shape. The upper vent groove 160 may be formed in a ring shape enclosing the housing shaft G.

The lower cover (or second cover) 130 covers the downward (or second) opening 112. The lower cover 130 may define a surface that intersects the housing shaft G. An electrode terminal (not illustrated) may be formed in the lower cover 130. Preferably, a positive terminal (not illustrated) connected to the positive electrode plate and a negative electrode terminal (not illustrated) connected to the negative electrode plate may be formed in the lower cover 130. In the example shown in FIG. 6, the lower cover (or second cover) 130 may be provided at an upper region of the battery housing 40 to face the handle 30, so terminals provided on second cover 130 may be coupled to corresponding electrical terminals provided in the handle 30.

Because the lower cover 130 and the lead frame are connected to each other by welding, when a vent groove is formed in the lower cover 130, damage to the vent groove (e.g., during the welding process) may cause the battery cell 100 to also be damaged. Accordingly, the present disclosure solves such problems by forming a vent groove in the side cover 110, as described later, without forming a vent groove or other opening in the lower cover 130.

One or more side vent grooves 150 are formed in the side cover 110. For example, the side vent grooves 150 may be formed by etching or carving away one or more regions of an inner or an outer surface of the side cover 110. The side vent grooves 150 may have a structure to be damaged (e.g., perforated) when a pressure inside the cell housings 110, 120, and 130 exceeds a preset pressure. Further, the side vent groove 150 may have a structure that is damaged and deformed when a pressure inside the cell housings 110, 120, and 130 exceeds a preset pressure to guide a discharge direction of the exhaust gas discharged from the inside of the cell housings 110, 120, and 130.

The side vent groove 150 may be located adjacent to the lower end at the side of the cell housings 110, 120, and 130. For instance, in the example shown in FIG. 6 in which the lower cover (or second cover) 130 is provided at an upper region of the battery housing 40 to provide upward facing terminals, side vent groove 150 may be positioned closer to the first cover 120 at the bottom of the housing 40. In one implementation, the one or more side vent grooves 150 may be provided in the externally facing surfaces of the battery housing 40 (such as the flat side surface) and not provide in other surfaces that are not externally exposed (such as a surface facing the cleaner body 10). For example, the side vent groove 150 may be formed by recessing a part of the side cover 110. For another example, the side vent groove 150 may be defined as an area having a thickness relatively less than that of adjacent portions of the side cover 110. For example, a portion of the side cover 110 having a smaller thickness than a reference thickness may be defined as the side vent groove 150. The side vent groove 150 has a thickness relatively smaller than that of other portions of the side cover 110. It is easy to produce that the side vent groove 150 that is made of the same material as that of the side cover 110, such as by removing a portion of an exterior surface of the side cover. In another example, the side vent groove 150 may be defined as an area of the side cover 110 composed of a relatively softer material than other portions of the side cover 110, and a thickness (in a radial direction) of the side cover 110 at the side vent groove 150 may correspond to a reference thickness or the thickness of the side cover 110 at other locations.

A cross-sectional shape of the side vent groove 150 may correspond to a V or U shape. The side vent groove 150 may be extended in one direction in a line shape. Further, the side vent groove 150 may have a shape in which a plurality of straight lines are connected to each other or may have a circular shape. Further, the side vent groove 150 may be connected continuously. Further, a plurality of side vent grooves 150 may be disposed to be spaced apart from each other.

For example, the side vent groove 150 may be formed in a substantially ring shape enclosing the housing shaft G. The side vent groove 150 defines a closed curve enclosing the housing shaft G. Specifically, the side vent groove 150 is extended substantially along a circumference of the side cover 110. While the side vent groove 150 is extended along the circumference of the side cover 110, the side vent groove 150 may have a disconnected portion in the middle. The side vent groove 150 may be extended in a direction parallel to that of the lower cover 130.

For another example, the side vent groove 150 may include a first side vent groove 151 extended in a direction parallel to that of the lower cover 130 and a second side vent groove 152 extended in a direction parallel to that of the lower cover 130 and spaced upward from the first side vent groove 151. The first side vent groove 151 and the second side vent groove 152 may define a closed curve enclosing the housing shaft G. As another example, the side vent groove 150 may be a plurality of lines or slits extended in a direction parallel to that of the lower cover 130.

When the side vent groove 150 is formed along the circumference of the side cover 110, the vent groove may be formed in a larger area than the lower cover 130 and thus it is possible to lower a pressure of the exhaust gas discharged from the cell housings 110, 120, and 130 and to reduce damage to components other than the battery due to the pressure of the exhaust gas.

The side vent groove 150 may be disposed to be biased toward the lower cover 130 in the side cover 110. For example, a distance between the side vent groove 150 and the lower cover 130 may be 0.5 mm to 2 mm. When the side vent groove 150 is disposed to be biased toward the lower cover 130, a movement of the battery cell 100 may be prevented by balance between the exhaust gas discharged from the upper vent groove 160 of the upper cover 120 and the exhaust gas discharged from the side vent groove 150.

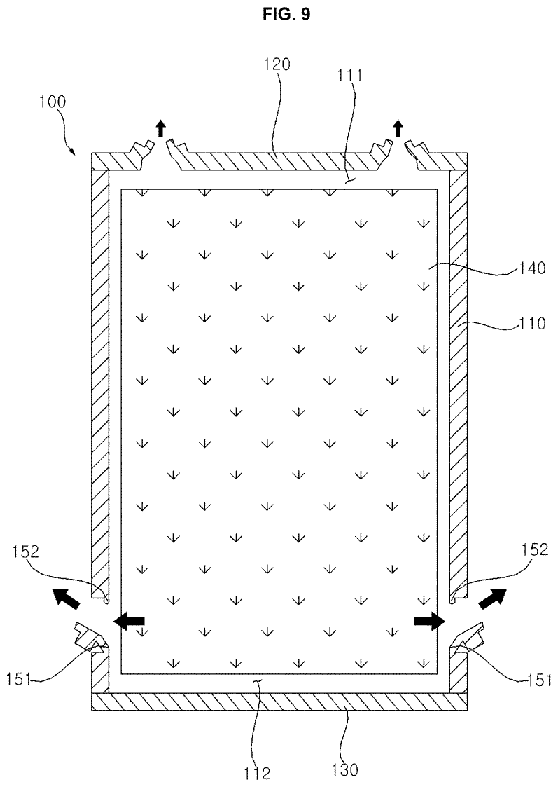

Referring to FIG. 9, when gas is excessively generated in the cell housings 110, 120, and 130 due to a cause, such as overcharging or an internal short circuit, and a pressure is thus increased, the increased pressure may cause the side vent groove 150 to be damaged such that a space or opening communicating between the inside and the outside of the cell housings 110, 120, and 130 is generated at the side vent groove 150. When exhaust gas inside the cell housings 110, 120, and 130 is ejected through the space, explosion of the battery cell 100 may be prevented due to the pressure relief. Additionally, the upper vent groove 160 may also be damaged, and gas may be discharged into via the damage space associated with upper vent groove 160 (e.g., downward when the upper vent groove 160 is positioned at a bottom of the handle 30, as depicted in FIG. 6).

### Second Embodiment

Hereinafter, a battery cell 100A according to the second embodiment will be described. Hereinafter, a description will be made mainly on differences from the first embodiment (FIGS. 7 and 8), and the same description will be omitted. Configurations without special description are regarded as the same as in the first embodiment.

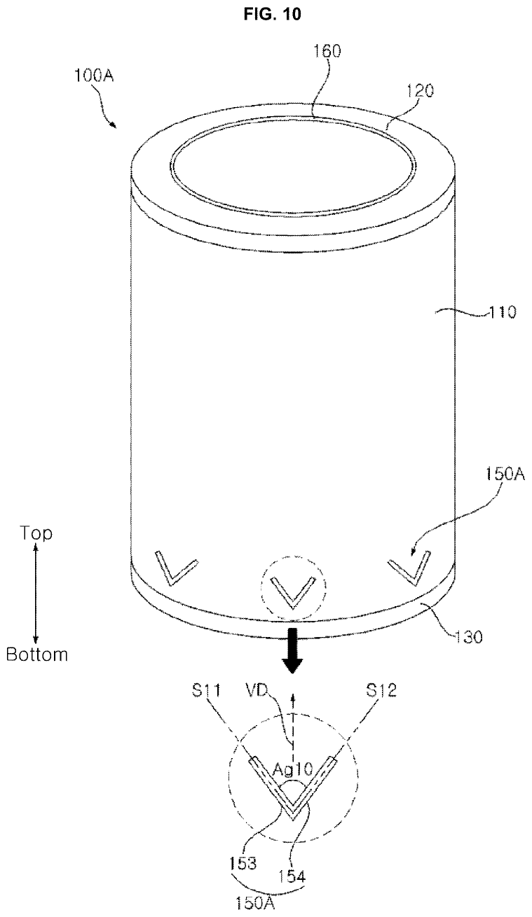

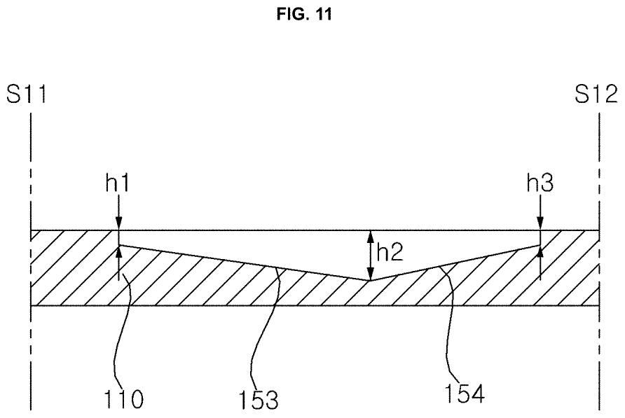

Referring to FIGS. 10 and 11, the second embodiment differs from the first embodiment in a structure, a shape, and a positioning of a side vent groove 150A. In the side vent groove 150A according to the second embodiment, while the side vent groove 150A is damaged by a pressure inside the cell housings 110, 120, and 130, the side cover 110 around the side vent groove 150A is deformed, and thus, the side vent groove 150A may have a structure that guides a discharge direction of the exhaust gas.

A plurality of side vent grooves 150A may be disposed to be spaced apart from each other. Specifically, a plurality of side vent grooves 150A may be disposed along a circumference of the side cover 110. For example, the side vent groove 150A may include a first open vent groove (or first vent groove) 153 extended in a first direction and a second open vent groove (or second vent groove) 154 extended in a second direction to intersect and be connected to one end of the first open vent groove 153, such as to form a V or a U shape. One end of the first open vent groove 153 is connected to one end of the second open vent groove 154. The first open vent groove 153 and the second open vent groove 154 may each have a straight or curved shape.

One end of the first open vent groove 153 and one end of the second open vent groove 154 may be connected to each other, and a distance between the first open vent groove 153 and the second open vent groove 154 may increase as advancing in a direction from one end to the other end of the first open vent grooves 153. The first direction and the second direction may be a direction between an upper part and a lateral direction.

An angle Ag10 formed between the first open vent groove 153 and the second open vent groove 154 may be an acute angle. In certain implementations, the angle Ag10 formed between the first open vent groove 153 and the second open vent groove 154 may be 20 degrees to 40 degrees. The first open vent groove 153 and the second open vent groove 154 may have a V-shape. When the side cover 110 is cut along the first open vent groove 153 and the second open vent groove 154, a large space for discharging exhaust gas may be formed, so that a pressure of the exhaust gas of the battery cell 100 becomes very low, and an amount of exhaust gas that can be discharged per unit of time (e.g., hour) is relatively large.

The distance between the first open vent groove 153 and the second open vent groove 154 may increase in an upward direction. When the angle between the first open vent groove 153 and the second open vent groove 154 is smaller than 20 degrees, when the side cover 110 is cut by the exhaust gas, a space in which exhaust gas is sufficiently discharged is not secured, and when the angle between the first open vent groove 153 and the second open vent groove 154 is greater than 40 degrees, it is difficult for the side cover 110 to be cut along the first open vent groove 153 the second open vent groove 154 by the exhaust gas and it is difficult for the side cover 110 to be deformed.

A direction VD of a middle of an angle between the first open vent groove 153 and the second open vent groove 154 may form an angle within 45 degrees of an upward direction (e.g., along a vertical section of the side cover 110). In one example, the direction VD of the angle between the first open vent groove 153 and the second open vent groove 154 may be parallel to the upward direction. When the direction VD of the angle between the first open vent groove 153 and the second open vent groove 154 is parallel to the upward direction, the side cover 110 is cut along the first open vent groove 153 and the second open vent groove 154 by the exhaust gas to guide the exhaust gas in a direction between the lower side edge and the side surface of the side cover 110. When the exhaust gas is discharged between the lower side and the side, the sum of force vectors of the exhaust gas discharged from the upper vent groove 160 may be close to zero, and thus, the battery cell 100A is prevented from being discharged.

Referring to FIG. 11, a depth h2 of one end of the first open vent groove 153 may be deeper than a depth h1 of the other end of the first open vent groove 153, and the depth h2 of one end of the second open vent groove 154 may be deeper than a depth h3 of the other end of the second open vent groove 154. Thus, side vent grooves 150A may be deepest at an intersection of first open vent groove 153 and the second open vent groove 154. As another example, a depth of the first open vent groove 153 may increase as advancing from the other end toward one end, and a depth of the second open vent groove 154 may increase as advancing in a direction from the other end toward one end.

When a depth of a portion where the first open vent groove 153 and the second open vent groove 154 are connected is relatively deep, the damage to the side cover 110 starts at intersecting ends of the first open vent groove 153 and the second open vent groove 154 by exhaust gas, and the damage proceeds in a direction of the other end of the first open vent groove 153 and the other end of the second open vent groove 154, the side cover 110 between the first open vent groove 153 and the second open vent groove 154 is bent outwards to provide a space for the exhaust gas.

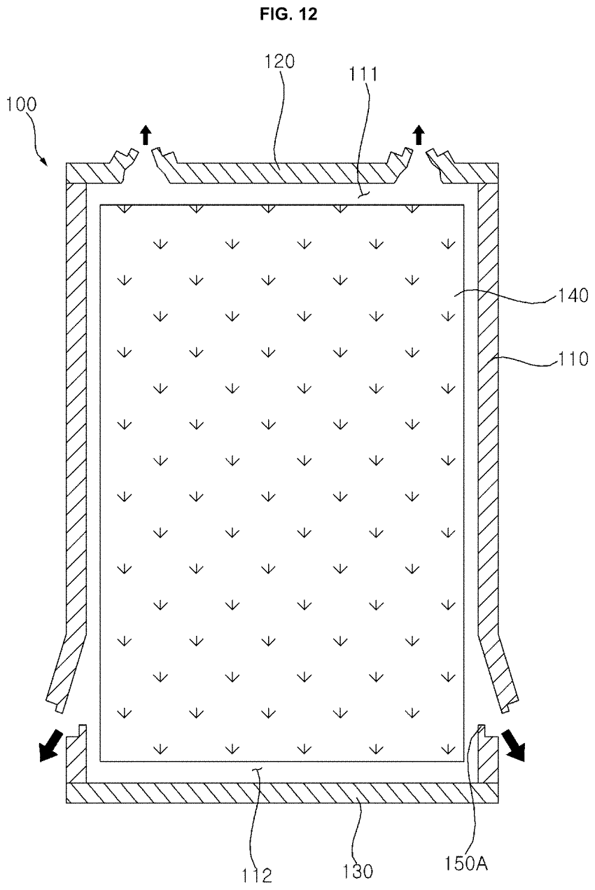

Referring to FIG. 12, when gas is excessively generated in the cell housings 110, 120, and 130 due to a cause, such as overcharging or an internal short, and a pressure is thus increased, the damage to the side cover 110 is started from first ends of the first open vent groove 153 and the second open vent groove 154, and the damage proceeds in a direction toward the other ends of the first open vent groove 153 and the second open vent groove 154, the side cover 110 between the first open vent groove 153 and the second open vent groove 154 is bent, and the side cover 110 is opened. Since the first open vent groove 153 and the second open vent groove 154 are spaced from a lower one of covers 120 and 130, a discharge of potentially hazard chemicals associated with core material 140, such as a waste liquid, may be minimized through a resulting opening. When exhaust gas is ejected into the open space of the side cover 110, an exhaust gas discharge direction is guided between a radially outward direction and a lower (e.g., downward) direction by a bent portion of the side cover 110. In the example shown in FIG. 6 in which second cover 130 (having terminals) is positioned to face upward when inserted in handle 30, the first open vent groove 153 and the second open vent groove 154 may oriented to be closer to the first cover 120 and/or to open downward when damaged so that gas is exhausted downward and away from a user.

### Third Embodiment

Hereinafter, a battery cell 100B according to the third embodiment will be described. Hereinafter, a description will be made mainly on differences from the second embodiment (FIGS. 10 and 11), and the same description will be omitted. Configurations without special description are regarded as the same as in the second embodiment.

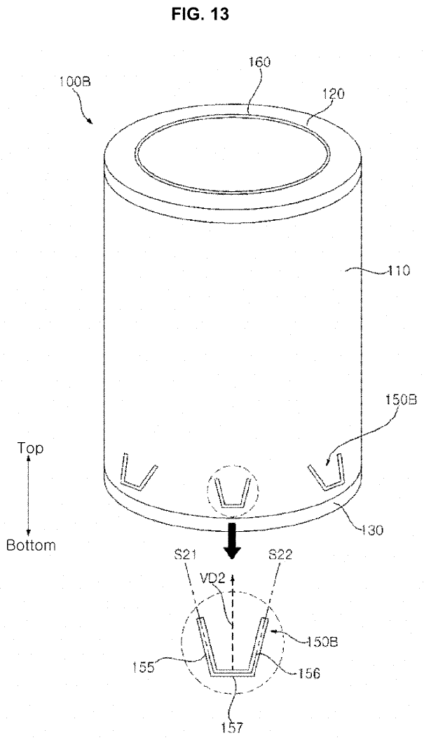

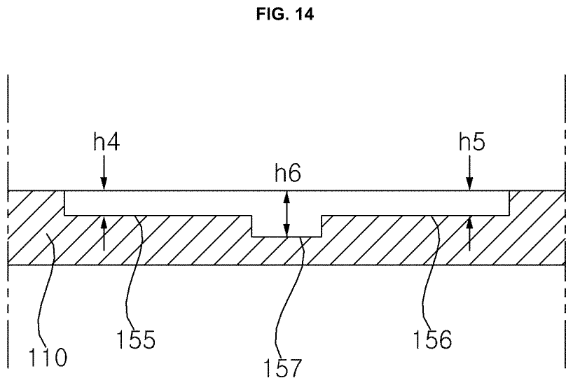

Referring to FIGS. 13 and 14, the third embodiment differs from the second embodiment in a structure of a side vent groove 150B. In the side vent groove 150B according to the third embodiment, while the side vent groove 150B is damaged by a pressure inside the cell housings 110, 120, and 130, the side cover 110 around the side vent groove 150B is deformed and thus the side vent groove 150B may have a structure that guides a discharge direction of the exhaust gas.

For example, the side vent groove 150B includes a first open vent groove 155 extended in a first direction, a second open vent groove 156 extended in a second direction, and a third open vent groove 157 for connecting corresponding (e.g., lower) ends of the first open vent groove 155 and the second open vent groove 156. One end of the first open vent groove 155 and one end of the second open vent groove 156 are connected to corresponding ends of the third open vent groove 157. The third open vent groove 157 may be extended in a direction crossing a vertical direction. Preferably, the third open vent groove 157 may be extended in a direction parallel to that of the lower cover 130 (e.g., in a horizontal direction and/or a circumferential direction of the side cover 110). A distance between the first open vent groove 155 and the second open vent groove 156 may increase in a direction toward the upper cover 120 (e.g., in an upper direction) from ends of the first open vent groove 155 and the second open vent groove 156 intersecting the third open vent groove 157.

An angle between the first open vent groove 155 and the second open vent groove 156 may be an acute angle. Preferably, the angle between the first open vent groove 155 and the second open vent groove 156 may be 10 to 30 degrees. Initially, because the exhaust gas discharge space is largely secured by the third open vent groove 157, there is no need for a large angle between the first open vent groove 155 and the second open vent groove 156.

A direction VD2 of an angle between the first open vent groove 155 and the second open vent groove 156 may form an angle within 45 degrees from an upward direction. Preferably, the direction VD2 of the angle between the first open vent groove 155 and the second open vent groove 156 may be parallel to the upward direction. When the direction VD2 of the angle formed between the first open vent groove 155 and the second open vent groove 156 is parallel to the upward direction, the side cover 110 guides the exhaust gas in a direction between the lower side and the side while being cut along the first open vent groove 155 and the second open vent groove 156 by the exhaust gas.

Referring to FIG. 14, a depth h6 of the third open vent groove 157 may be greater than a depth h4 of the first open vent groove 155 and a depth h5 of the second open vent groove 156. In one example, the depth of the first open vent groove 155 and the depth of the second open vent groove 156 may increase as they approach the third open vent groove 157 (e.g., in a downward direction). In one example, the depth of the third open vent groove 157 may increase in a direction advancing inward from both ends and toward the center.

When the depth of the third open vent groove 157 is deep, damage is started from the third open vent groove 157 by exhaust gas, while the damage proceeds in a direction of the other end of the first open vent groove 155 and the other end of the second open vent groove 156, the side cover 110 between the first open vent groove 155 and the second open vent groove 156 is bent and opened. According to the third embodiment, an initial large amount of exhaust gas can be discharged, so that the pressure of the exhaust gas can be made very low initially.

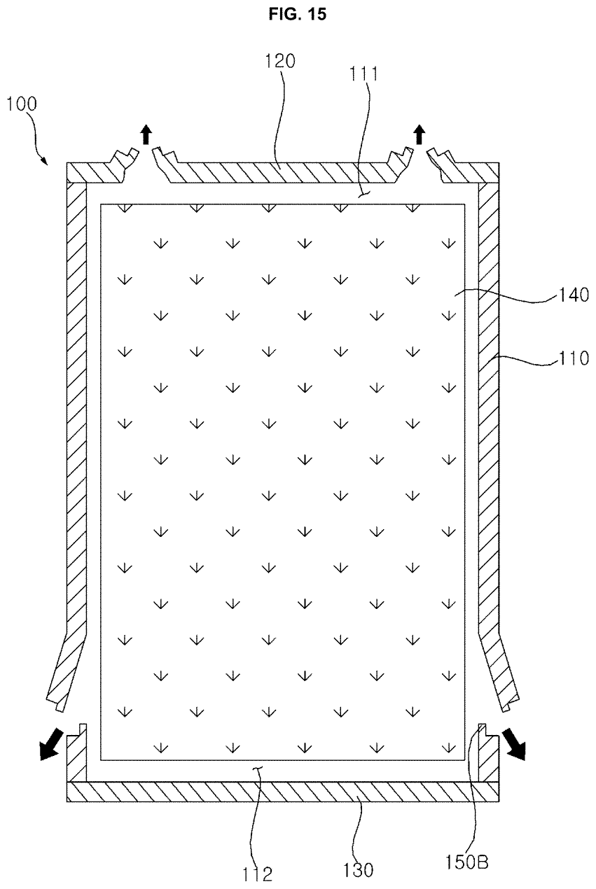

Referring to FIG. 15, when gas is excessively generated in the cell housings 110, 120, and 130 due to an overcharge or an internal short circuit, and the pressure is thus increased, the damage is started from the third open vent groove 157. As the damage proceeds in a direction of the other end of the first open vent groove 155 and the other end of the second open vent groove 156, the side cover 110 between the first open vent groove 155 and the second open vent groove 156 is bent and opened. When exhaust gas is ejected into the open space of the side cover 110, the exhaust gas discharge direction is guided between an outer direction and a lower direction by the bent portion of the side cover 110.

Through the above solution, a battery cell is prevented from being discharged from a battery pack, and the risk of damage to components around the battery due to the discharge of the battery cell is reduced, along with reducing the risk of injury to a user, even if exhaust gas is discharged by disposing an exhaust gas discharge structure at the side of the battery cell. Further, in the present disclosure, because an exhaust gas discharge structure is disposed at the side of a battery cell and the exhaust structure is not disposed at the end of the battery cell, the possibility that the exhaust structure is damaged when welding for electrode connection is low, and that welding for electrode connection is easy.

Further, the present disclosure has a gas discharge structure located close to a lower surface at the side of the battery cell and an upper surface of the battery cell, so that the exhaust gas is discharged in one direction and does not operate as a driving force of the battery cell, and the side of the battery cell is wider than the upper and lower surfaces thereof and thus a large number of discharge structures or wide discharge structures are formed in a large space, thereby reducing an ejection speed of the exhaust gas.

Further, in the present disclosure, while the gas discharge structure formed at the side of the battery cell is cut from the bottom to the top, because exhaust gas is ejected, and the upper end of the gas discharge structure is connected to the side of the battery cell, when the exhaust gas is discharged from the battery cell, a discharge direction of the exhaust gas is adjusted between the lower side (e.g., bottom surface) and the side (e.g., vertical surface), so that discharge of exhaust gas does not act as a driving force of the battery cell and is made in a direction of reducing damage to other components and that the gas discharge structure is prevented from being separated from the battery cell.

A first aspect of the present disclosure provides a battery cell that does not discharge from a battery pack, even if the exhaust gas is discharged by disposing an exhaust gas discharge structure at the side of the battery cell. A second aspect of the present disclosure provides a battery cell with a low possibility that an exhaust structure will be damaged when welding for electrode connection because an exhaust gas discharge structure is disposed at the side of the battery cell and the exhaust structure is not disposed at the side of the battery cell.

A third aspect of the present disclosure provides a battery cell in which an exhaust gas discharge structure does not escape from the battery cell when exhaust gas is discharged from the battery cell. A fourth aspect of the present disclosure provides a battery cell that adjusts a discharge direction of exhaust gas to a direction in which the battery cell is not discharged and that adjusts a discharge direction of exhaust gas to a direction that reduces the risk of damage to peripheral components, when the exhaust gas is discharged from the battery cell.

Accordingly, the present disclosure relates to disposing an exhaust gas discharge structure at the side of a battery cell. Further, the present disclosure is characterized by a V-groove for discharging the exhaust gas at an angle between the bottom and the side at the side of the battery cell.

In an aspect, a battery cell includes a core material for providing electrical energy; and a cell housing for receiving the core material, wherein the cell housing includes a side cover opened in a vertical direction and for enclosing a housing shaft; an upper cover for shielding an upward opening of the cell housing; a lower cover for shielding a downward opening of the sell housing; and a side vent groove formed in the side cover.

The side vent groove may be disposed to be biased toward the lower cover from the side cover. A distance between the side vent groove and the lower cover may be 0.5 mm to 2 mm. The side vent groove may have a smaller thickness than that of the side cover.

The side vent groove may include the same material as that of the side cover. The side vent groove may be extended in a direction parallel to that of the lower cover. The side vent groove may define a closed curve enclosing the housing shaft.

The side vent groove may include a first side vent groove extended in a direction parallel to that of the lower cover, and a second side vent groove extended in a direction parallel to that of the lower cover and spaced upward from the first side vent groove. The first side vent groove and the second side vent groove may define a closed curve enclosing the housing shaft.

The side vent groove may include a first open vent groove extended in the first direction, and a second open vent groove extended in a second direction and connected to one end of the first open vent groove. An angle between the first open vent groove and the second open vent groove may be an acute angle. A depth of one end of the first open vent groove may be deeper than that of the other end of the first open vent groove, a depth of one end of the second open vent groove may be deeper than that of the other end of the second open vent groove, and one end of the first open vent groove may be connected to one end of the second open vent groove. A direction of the angle between the first open vent groove and the second open vent groove may form an angle within 45 degrees from an upward direction.

The side vent groove may further include a third open vent groove for connecting one end of the first open vent groove and one end of the second open vent groove, and a distance between the first open vent groove and the second open vent groove may increase as advancing in an upward direction.

A depth of the third open vent groove may be deeper than depths of the first open vent groove and the second open vent groove. A depth of the first open vent groove and a depth of the second open vent groove may become deeper as approaching the third open vent groove.

The cell housing may further include an upper vent groove formed in the upper cover. The upper vent groove may have a line shape enclosing the housing shaft.

In another aspect, a battery cell includes a core material for providing electrical energy; and a cell housing for receiving the core material, wherein the cell housing includes a side cover opened in a vertical direction and for enclosing a housing shaft; an upper cover for shielding an upward opening of the cell housing; a lower cover for shielding a downward opening of the sell housing; and a side vent groove formed in the side cover to be damaged when a pressure inside the cell housing exceeds a preset pressure. Further, the present disclosure includes a cleaner including the battery cell. For example, the battery cell may be included in a handle of the cleaner, the at least one side vent groove formed in a side cover of the battery cell may prevent accumulated gas in the battery cell from damaging the handle or being harmfully vented to a user's hand holding the grip.

### Advantageous Effects

Through the above solution, a first aspect of the present disclosure relates to preventing a battery cell from being discharged from a battery pack, reducing the risk of damage to components around the battery due to the discharge of the battery cell, and reducing the risk of injury to a user, even if exhaust gas is discharged by disposing an exhaust gas discharge structure at the side of the battery cell.

Further, in the present disclosure, because an exhaust gas discharge structure is disposed at the side of a battery cell and the exhaust structure is not disposed at the side of the battery cell, the possibility that the exhaust structure is damaged when welding for electrode connection is low, and that welding for electrode connection is easy.

Further, the present disclosure has a gas discharge structure located close to a lower surface at the side of the battery cell and an upper surface of the battery cell, so that the exhaust gas is discharged in one direction and does not operate as a driving force of the battery cell, and the side of the battery cell is wider than the upper and lower surfaces thereof and thus a large number of discharge structures or wide discharge structures are formed in a large space, thereby reducing an ejection speed of the exhaust gas.

Further, in the present disclosure, while the gas discharge structure formed at the side of the battery cell is cut from the bottom to the top, because exhaust gas is ejected, and the upper end of the gas discharge structure is connected to the side of the battery cell, when the exhaust gas is discharged from the battery cell, a discharge direction of the exhaust gas is adjusted between the lower side and the side, so that discharge of exhaust gas does not act as a driving force of the battery cell and is made in a direction of reducing damage to other components and that the gas discharge structure is prevented from being separated from the battery cell.

It will be understood that when an element or layer is referred to as being “on” another element or layer, the element or layer can be directly on another element or layer or intervening elements or layers. In contrast, when an element is referred to as being “directly on” another element or layer, there are no intervening elements or layers present. As used herein, the term “and/or” includes any and all combinations of one or more of the associated listed items.

It will be understood that, although the terms first, second, third, etc., may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section could be termed a second element, component, region, layer or section without departing from the teachings of the present invention.

Spatially relative terms, such as “lower”, “upper” and the like, may be used herein for ease of description to describe the relationship of one element or feature to another element(s) or feature(s) as illustrated in the figures. It will be understood that the spatially relative terms are intended to encompass different orientations of the device in use or operation, in addition to the orientation depicted in the figures. For example, if the device in the figures is turned over, elements described as “lower” relative to other elements or features would then be oriented “upper” relative to the other elements or features. Thus, the exemplary term “lower” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Embodiments of the disclosure are described herein with reference to cross-section illustrations that are schematic illustrations of idealized embodiments (and intermediate structures) of the disclosure. As such, variations from the shapes of the illustrations as a result, for example, of manufacturing techniques and/or tolerances, are to be expected. Thus, embodiments of the disclosure should not be construed as limited to the particular shapes of regions illustrated herein but are to include deviations in shapes that result, for example, from manufacturing.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Any reference in this specification to “one embodiment,” “an embodiment,” “example embodiment,” etc., means that a particular feature, structure, or characteristic described in connection with the embodiment is included in at least one embodiment of the invention. The appearances of such phrases in various places in the specification are not necessarily all referring to the same embodiment. Further, when a particular feature, structure, or characteristic is described in connection with any embodiment, it is submitted that it is within the purview of one skilled in the art to effect such feature, structure, or characteristic in connection with other ones of the embodiments.

Although embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. A battery cell, comprising:
a core material for providing electrical energy; and
a cell housing to define a cavity for receiving the core material,
wherein the cell housing includes:
a side cover that extends to define the cavity and has a first opening and second opening;
an first cover provided at the first opening of the cell housing;
a second cover provided at second opening of the cell housing; and
at least one side vent groove formed in the side cover.

2. The battery cell of claim 1, wherein the side vent groove is positioned to be closer to the second cover than the first cover, and the second cover is positioned lower than the first cover.

3. The battery cell of claim 1, wherein a distance between the side vent groove and the lower one of the first cover or the second cover is 0.5 mm to 2 mm.

4. The battery cell of claim 1, wherein the side cover has a thickness that is less at the side vent groove than at another region of the side cover that differs from the side vent groove.

5. The battery cell of claim 1, wherein the side cover is formed of a common material at the side vent groove and at another at another region of the side cover away from the side vent groove.

6. The battery cell of claim 1, wherein the side vent groove is extended in a direction parallel to that of the second cover.

7. The battery cell of claim 1, wherein the side vent groove defines a closed curve around the core material.

8. The battery cell of claim 1, wherein the side vent groove includes:
a first side vent groove extended in a first direction parallel to that of the second cover; and
a second side vent groove extended in a second direction parallel to that of the second cover and spaced vertically from the first side vent groove.

9. The battery cell of claim 8, wherein each of the first side vent groove and the second side vent groove defines a closed curve around the core material.

10. The battery cell of claim 1, wherein the at least one side vent groove includes:
a first vent groove extended in the first direction; and
a second vent groove extended in a second direction and intersecting the first vent groove.

11. The battery cell of claim 10, wherein an angle between the first vent groove and the second vent groove is an acute angle.

12. The battery cell of claim 10, wherein:
each of the first vent groove and the second vent groove includes a first end and second end,
the first end of the first vent groove is connected to the first end of the second vent groove,
a depth of the first end of the first vent groove is greater than a depth of the second end of the first vent groove, and
a depth of the first end of the second vent groove is greater than a depth of the second end of the second vent groove.

13. The battery cell of claim 11, wherein a middle of the angle between the first vent groove and the second vent groove extends within 45 degrees of a direction between the first cover and the second cover.

14. The battery cell of claim 10, wherein the side vent groove further includes a third vent groove that connects the first vent groove and the second vent groove, and
a distance between the first vent groove and the second vent groove increases in a direction between the second over and the first cover.

15. The battery cell of claim 14, wherein a depth of the third vent groove is greater than depths of the first vent groove and the second vent groove.

16. The battery cell of claim 14, wherein a depth of the first vent groove and a depth of the second vent groove increase towards the third vent groove.

17. The battery cell of claim 1, wherein the cell housing further includes an end vent groove formed in the first cover.

18. The battery cell of claim 17, wherein the end vent groove encircles an axis of the side cover that extends between the first cover and the second cover.

19. A battery cell, comprising:
a core material for providing electrical energy; and
a cell housing the defines a cavity for receiving the core material,
wherein the cell housing includes:
a side cover that extends to form the cavity;
an end cover provided at an opening provided at a distal end of the side cover; and
at least one groove formed in the side cover, the side cover being perforated at the groove when a pressure inside the cavity exceeds a preset pressure.

20. A battery cell, comprising:
a core material for providing electrical energy;
a cell housing for receiving the core material, the cell housing including a side surface, a first distal end, and a second distal end that is positioned lower than the first distal end; and
a side vent groove provided at the side of the cell housing and positioned closer to the second distal end than the first distal end.
